(19) United States
(12) Patent Application Publication
(10) Pub. No.: US 2026/0072439 A1
(43) Pub. Date: Mar. 12, 2026

(54) MOBILE MACHINE FOR ADJUSTING SAFETY MARGIN AND MOVING METHOD THEREOF

(71) Applicant: SAMSUNG ELECTRONICS CO., LTD., Suwon-si (KR)

(72) Inventors: Minsu CHANG, Suwon-si (KR); Seungyeon KIM, Suwon-si (KR); Jun-Won JANG, Suwon-si (KR); Won Je CHOI, Suwon-si (KR); Daewoong HAN, Suwon-si (KR); Hyunkyu PARK, Suwon-si (KR)

(73) Assignee: SAMSUNG ELECTRONICS CO., LTD., Suwon-si (KR)

(21) Appl. No.: 19/305,009

(22) Filed: Aug. 20, 2025

(30) Foreign Application Priority Data
Sep. 9, 2024 (KR) 10-2024-0122422
Sep. 25, 2024 (KR) 10-2024-0129811

(51) Int. Cl. G05D 1/622; G01S 17/89; G01S 17/931; G05D 1/65; G05D 109/10; G05D 111/10

(52) U.S. Cl. CPC G05D 1/622; G01S 17/89; G01S 17/931; G05D 1/65; G05D 2109/10; G05D 2111/17

(57) ABSTRACT

A mobile machine for adjusting a safety margin and a moving method thereof are provided. The moving method includes generating a point cloud representing surrounding objects by sensing the surrounding objects of the mobile machine, determining tunnel candidates between the surrounding objects by using the point cloud, selecting a target tunnel from the tunnel candidates based on a planned path, setting a safety margin based on a width of the target tunnel, and moving along the planned path while performing collision avoidance based on the safety margin.

### CROSS-REFERENCE TO RELATED APPLICATION

This application is based on and claims priority from Korean Patent Application No. 10-2024-0122422 filed on Sep. 9, 2024, and Korean Patent Application No. 10-2024-0129811 filed on Sep. 25, 2024, in the Korean Intellectual Property Office, the disclosures of which are incorporated herein by reference in their entirety.

### BACKGROUND

### 1. Field

Methods and apparatuses consistent with example embodiments relate to a mobile machine, and in particular, a mobile machine configured to adjust a safety margin and a moving method of the mobile machine.

### 2. Description of the Related Art

In some cases, a path planning of a mobile machine may be performed by using a point cloud. The point cloud may include points collected by using light detection and ranging (LiDAR), an image sensor, a depth sensor, an ultrasonic sensor, or a combination thereof. The point cloud may express objects or environments in a three-dimensional (3D) space through points. The mobile machine may move to a target position while performing collision avoidance with surrounding obstacles through the path planning.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

According to an aspect of the disclosure, there is provided a method of moving a mobile machine, the method including: generating a point cloud corresponding to a plurality of objects in an area surrounding the mobile machine; determining tunnel candidates based on the point cloud corresponding to the plurality of objects; selecting a target tunnel from the tunnel candidates based on a planned path; setting a safety margin based on a width of the target tunnel; and moving along the planned path based on the safety margin.

According to another aspect of the disclosure, there is provided a controlling method of a mobile machine, the controlling method including: receiving a point cloud corresponding to a plurality of objects in an area surrounding the mobile machine; determining tunnel candidates based on the point cloud corresponding to the plurality of objects; selecting a target tunnel from the tunnel candidates based on a planned path; and determining a safety margin for collision avoidance based on a difference between a width of the mobile machine and a width of the target tunnel.

According to another aspect of the disclosure, there is provided a mobile machine including: one or more sensors configured to sense a plurality of objects in an area surrounding the mobile machine; one or more processors configured to: determine tunnel candidates based on a point cloud corresponding to the plurality of objects, select a target tunnel from the tunnel candidates based on a planned path, and set a safety margin based on a width of the target tunnel; and a driving system configured to move the mobile machine along the planned path based on the safety margin.

### BRIEF DESCRIPTION OF DRAWINGS

The above and/or other aspects will be more apparent by describing certain example embodiments, taken in conjunction with the accompanying drawings, in which:

FIG. 1 is a diagram schematically illustrating exemplary configurations related to collision avoidance-based driving of a mobile machine, according to an embodiment;

FIG. 2 is a diagram illustrating exemplary operations for driving a mobile machine, according to an embodiment;

FIG. 3 is a flowchart illustrating a moving method of a mobile machine, according to an embodiment;

FIG. 4 is a diagram illustrating an example of a process of generating a point cloud and a planned path, according to an embodiment;

FIG. 5 is a diagram illustrating an example of a process of determining tunnel candidates, according to an embodiment;

FIG. 6 is a diagram illustrating an example of a process of determining a target tunnel from the tunnel candidates, according to an embodiment;

FIG. 7 is a diagram illustrating an example of a process of determining a target tunnel by using a tunnel line and a sub-path line;

FIG. 8 is a diagram illustrating an example of a process of determining a safety margin width, according to an embodiment;

FIG. 9 is a diagram illustrating an example of a situation where a wide safety margin is set, according to an embodiment;

FIG. 10 is a diagram illustrating an example of a situation where a narrow safety margin is set, according to an embodiment;

FIG. 11 is a flowchart illustrating an example of a detailed operation of a mobile machine for adjusting a safety margin, according to an embodiment;

FIGS. 12A and 12B are diagrams illustrating an example of a point-based tunnel search and a cluster-based tunnel search, according to an embodiment;

FIG. 13 is a diagram illustrating an example of a process of updating the width of a target tunnel, according to an embodiment;

FIG. 14 is a diagram illustrating an example of a tunnel search process using all points of a point cloud without a search area, according to an embodiment;

FIG. 15 is a diagram illustrating an example of a tunnel search process using partial points of a point cloud by using a search area, according to an embodiment;

FIG. 16 is a diagram illustrating an example of a process of estimating safety margin data by using a neural network model, according to an embodiment;

FIG. 17 is a block diagram illustrating an example of a configuration of a control device for a mobile machine, according to an embodiment;

FIG. 18 is a flowchart illustrating a controlling method of a mobile machine, according to an embodiment; and

FIG. 19 is a block diagram illustrating an example of a configuration of a mobile machine, according to an embodiment.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C,” and the like, each of which may include any one of the items listed together in the corresponding one of the phrases, or all possible combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto is omitted.

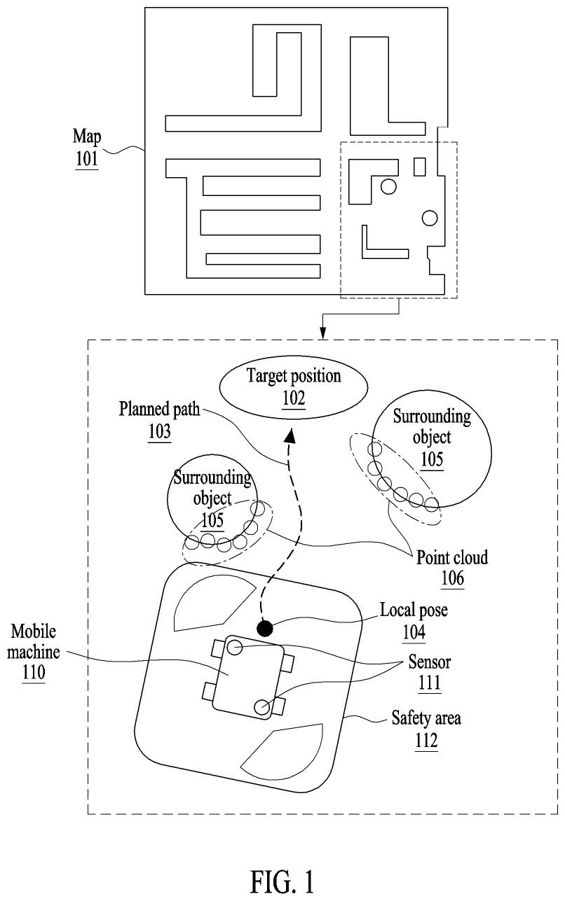

FIG. 1 is a diagram schematically illustrating exemplary configurations related to collision avoidance-based driving of a mobile machine, according to an embodiment. Referring to FIG. 1, a mobile machine 110 may move to a target position 102 along a planned path 103 based on autonomous driving. For example, the mobile machine 110 may include various machines or devices that perform autonomous driving. For example, the mobile machine 110 may include, but is not limited to, robots, robot vacuum cleaners, vehicles, airplanes, drones, trains, or personal mobility devices.

The mobile machine 110 may move to the target position 102 while sensing a surrounding object 105 by using a sensor 111 and performing collision avoidance with the surrounding object 105. The sensor 111 may include one or more sensor components. For example, the sensor 111 may include, but is not limited to, light detection and ranging (LiDAR), an image sensor, a depth sensor, an ultrasonic sensor, or a combination thereof.

The mobile machine 110 may generate a point cloud 106 representing the surrounding object 105 by using the sensor 111. The point cloud 106 may include numerous three-dimensional (3D) points. The 3D points may represent 3D coordinates. For example, the 3D points may represent 3D coordinates of an environment surrounding the mobile machine 110. The mobile machine 110 may determine a local pose 104 by using the 3D points. The local pose 104 may represent the position and/or direction of the mobile machine 110. The local pose 104 may be used to obtain or set a planned path 103 or perform collision avoidance. The surrounding object 105 may include various objects, such as fixed objects or moving objects. The fixed objects may include, but is not limited to, walls, pillars, furniture, etc. the moving objects may include, but is not limited to, people, animals, or vehicles, acting as obstacles to the driving of the mobile machine 110.

The mobile machine 110 may set the target position 102 and the planned path 103 by using a map 101. The mobile machine 110 may receive the map 101 from another device distinct from the mobile machine 110 or may generate the map 101 by itself. The target position 102 may be a destination of the mobile machine 110. For example, the target position 102 may be a final position to which the mobile machine 110 is attempting to reach or an intermediate position to reach the final position.

The mobile machine 110 may set a safety area 112 based on a surrounding environment including the surrounding object 105. The safety area 112 may be used as a virtual wall for collision avoidance. The mobile machine 110 may set the planned path 103 to prevent collision between the safety area 112 and the surrounding object 105 and may control the movement of the mobile machine 110.

According to an embodiment, the mobile machine 110 may adjust a safety margin adaptively or dynamically. The safety margin may be a margin for securing the safety area 112. In an example case in which a fixed safety margin is used, optimal movement may be difficult. For example, in an example case in which the safety margin is excessively wide, the mobile machine 110 may determine that a space may not be passed through despite that the space is sufficient for the mobile machine 110 to pass through on the planned path 103 formed by the surrounding object 105. In this case, the planned path 103 may not be optimized, or the mobile machine 110 may not move along the planned path 103. In an example case in which the safety margin is too narrow, the mobile machine 110 may move excessively close to the surrounding object 105, and thus may reduce driving safety. The mobile machine 110 may achieve optimal driving to the target position 102 by optimizing the safety margin according to the surrounding environment.

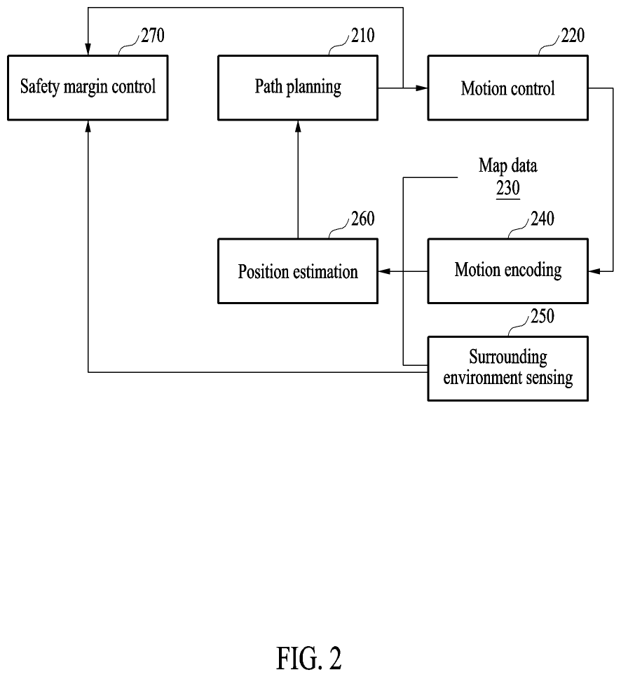

FIG. 2 is a diagram illustrating exemplary operations for driving a mobile machine, according to an embodiment. Referring to FIG. 2, the mobile machine may perform operations including, but not limited to, path planning 210 and motion control 220. For example, the mobile machine may perform path planning operations to obtain a planned path, and may perform motion control operations to move the mobile machine based on the planned path. The mobile machine may drive or move in the planned path through motion control 220. For example, the mobile machine may perform motion control 220 by using a driving system. For example, a moving speed, a moving direction, or a combination thereof may be controlled based on motion control 220. For example, the driving system may include components, such as power generation components (e.g., motors), power transmission components, steering components, or drivers, for implementing driving.

According to an embodiment, the mobile machine may further perform operation including, but not limited to, motion encoding 240, surrounding environment sensing 250, position estimation 260, and safety margin control 270. For example, the mobile machine may perform motion encoding 240 based on motion control 220. For example, in the motion encoding operation 240, motion data may be generated. The motion data may represent motion actually generated through motion control 220. For example, motion encoding 240 may be performed by sensing a driving situation of the driving system. The mobile machine may perform the surrounding environment sensing 250 by using a sensor. A point cloud may be generated based on the surrounding environment sensing 250.

The mobile machine may perform the position estimation 260 based on map data 230, the motion encoding 240, and the surrounding environment sensing 250. The current position of the mobile machine may be estimated based on the position estimation 260. The mobile machine may receive the map data 230 from another device distinct from the mobile machine or may generate the map data 230 by itself. The current position based on position estimation 260 may be used for path planning 210.

The mobile machine may perform safety margin control 270 based on the path planning 210 and/or the surrounding environment sensing 250. For example, the mobile machine may use the planned path and/or the point cloud for safety margin control 270. According to an embodiment, the mobile machine may identify a tunnel on the planned path and may set the safety margin based on the width of the tunnel. The mobile machine may move along the planned path based on the safety margin.

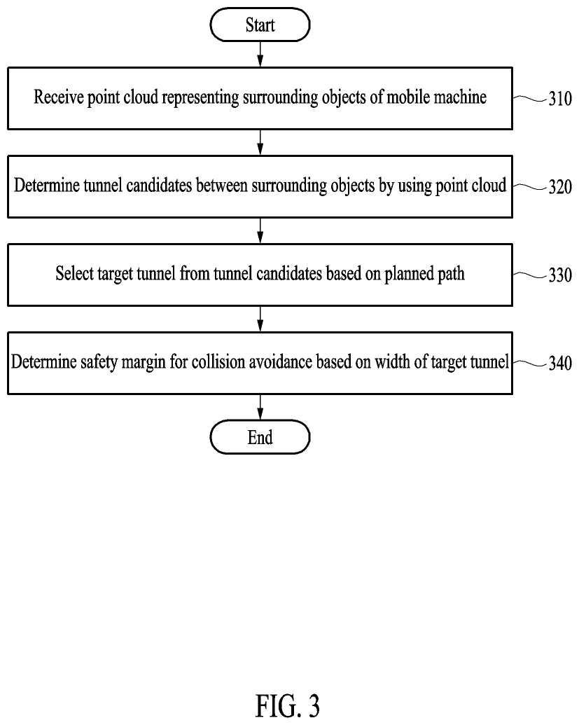

FIG. 3 is a flowchart illustrating a moving method of a mobile machine, according to an embodiment. Referring to FIG. 3, the mobile machine may receive a point cloud representing objects in an area surrounding the mobile machine in operation 310, may determine tunnel candidates between the surrounding objects by using the point cloud in operation 320, may select a target tunnel from the tunnel candidates based on a planned path in operation 330, and may determine a safety margin for collision avoidance based on the width of the target tunnel in operation 340. However, the disclosure is not limited thereto, and as such, according to an embodiment, the moving method of the mobile machine is not limited to the operations and/or the order of the operations illustrated in FIG. 3. For example, the moving method of the mobile machine may include one or more other operations. In an embodiment, the mobile machine may include a control device specialized in safety margin control, and operations 310 to 340 may be performed by this control device. However, the disclosure is not limited thereto. As such, according to another embodiment, the mobile machine may include an integrated control device for performing autonomous driving including safety margin control, and operations 310 to 340 may be performed by this integrated control device.

In operation 310, the method may include receiving the point cloud corresponding to one or more objects in the vicinity of the mobile machine. For example, the method may include receiving the point cloud corresponding to a plurality of objects in an area surrounding the mobile machine. For example, the point cloud may be data generated by sensing a surrounding object, such as a wall or furniture.

In operation 320, the method may include measuring of distances between points of the point cloud, identifying of consecutive points having a distance exceeding a threshold among the points, and determining of a space between the consecutive points to be the tunnel candidates. The points may form point groups based on clustering. Points spaced apart from one another at a distance less than the threshold may be classified into the same point group. A space between neighboring point groups may be determined as a tunnel candidate.

For example, the mobile machine may sense a surrounding environment in a certain rotational direction (e.g., a clockwise direction or a counterclockwise direction) and may sense the consecutive points through the sensing. The consecutive points may have different distances. In an example case in which a distance between two consecutive points exceeds the threshold, a space between the two consecutive points may be determined as a tunnel candidate. For example, after a first point is sensed, a second point after the first point may be sensed. The first point and the second point may be the consecutive points. In an example case in which the distance between the first point and the second point is less than the threshold, the first point and the second point may be classified into the same group. In an example case in which the distance between the first point and the second point is greater than or equal to the threshold, the first point and the second point may be classified respectively into different groups. In this case, a space between the first point and the second point may be determined as a tunnel candidate.

In operation 330, the method may include the selecting of a tunnel intersecting with the planned path as the target tunnel from among the tunnel candidates. The planned path may pass through one of the tunnel candidates, and one of the tunnel candidates may be determined as the target tunnel.

According to an embodiment, operation 330 may include determining of tunnel lines crossing a passing area of the tunnel candidates, determining of sub-path lines between path points on the planned path, and selecting of the target tunnel based on a geometric relationship between the tunnel lines and the sub-path lines. The passing area may be an area between points selected from each of the neighboring point groups of a tunnel. In an example case in which a first point group neighbors a second point group, the distance between the first point of the first point group and the second point of the second point group is the closest among points of the first point group and points of the second point group, an area between the first point and the second point may be the passing area. A line connecting the first point to the second point may be a tunnel line. The path points may be determined at certain distances on the planned path. Lines connecting neighboring path points among the path points may be determined as sub-path lines.

The tunnel candidates may have tunnel lines, respectively. The tunnel candidates may include a first tunnel candidate having a first tunnel line among the tunnel lines. In an example case in which the first tunnel line forms an intersection point with a first sub-path line among the sub-path lines, and the intersection point is within an area formed by the first tunnel line and the first sub-path line, the first tunnel candidate may be selected as the target tunnel.

The safety margin may be determined based on a difference between the width of the mobile machine and the width of the target tunnel. For example, operation 340 may include setting of the width of the safety margin to correspond to the difference between the width of the mobile machine and the width of the target tunnel. In an example case in which the mobile machine is projected as a rectangle from a bird's eye view, a width direction may be determined to be perpendicular to the frontal direction of the mobile machine, and the length of the width direction of the mobile machine may be the width of the mobile machine.

The mobile machine may control a moving speed based on the safety margin. For example, as the safety margin is wider, the mobile machine may increase the moving speed, and, as the safety margin is narrower, the mobile machine may decrease the moving speed. For example, the moving speed may be set proportional to the safety margin. In an example case in which the difference between the width of the mobile machine and the width of the target tunnel is great (e.g., greater than a threshold value), the probability of a collision is low when the mobile machine passes through the target tunnel. In this case, the moving speed of the mobile machine may be set high such that the mobile machine may pass through the target tunnel quickly. In an example case in which the difference between the width of the mobile machine and the width of the target tunnel is small (e.g., smaller than a threshold value), the probability of a collision is high when the mobile machine passes through the target tunnel. In this case, the moving speed of the mobile machine may be set low such that the mobile machine may pass through the target tunnel safely.

The safety margin may be set based on a safety area set around the mobile machine and a cost map set around the surrounding objects. The safety margin may be shared by the safety area and/or the cost map. For example, the safety margin may be shared one-to-one by the safety area and the cost map or may be shared at a greater ratio by any one of the safety area and the cost map. According to another embodiment, the entirety of the safety margin may be distributed across the safety area or the cost map.

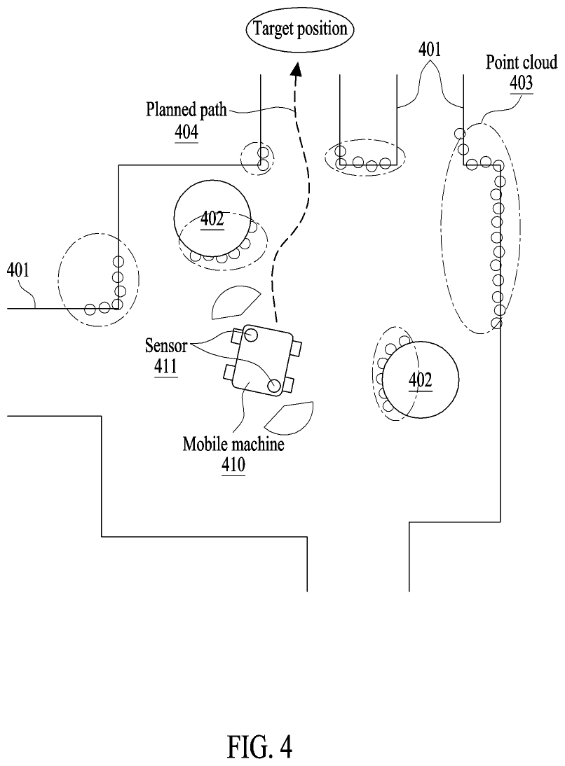

FIG. 4 is a diagram illustrating an example of a process of generating a point cloud and a planned path, according to an embodiment. Referring to FIG. 4, a mobile machine 410 may sense surrounding objects 401 and 402 by using a sensor 411. For example, the surrounding object 401 may be a wall and the surrounding object 402 may be a fixed object. As a result of the sensing, a point cloud 403 representing the surrounding objects 401 and 402 may be generated. The mobile machine 410 may set a safety margin by using the point cloud 403 and/or a planned path 404.

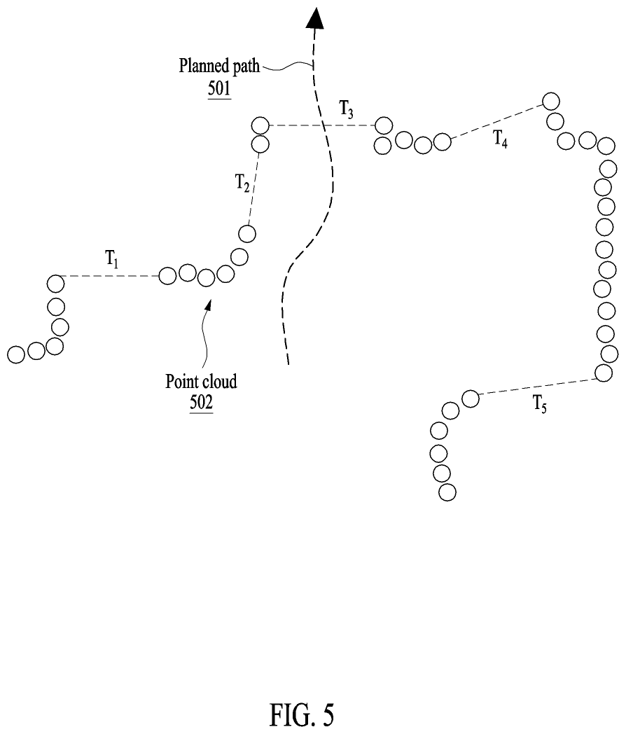

FIG. 5 is a diagram illustrating an example of a process of determining tunnel candidates, according to an embodiment. Referring to FIG. 5, a mobile machine may determine tunnel candidates between surrounding objects by using a point cloud 502. For example, the tunnel candidates may include, but is not limited to, a first tunnel candidate T₁, a second tunnel candidate T₂, a third tunnel candidate T₃, a fourth tunnel candidate T₄, and a fifth tunnel candidate T₅. The surrounding objects may correspond to the surrounding objects 401 and 402 of FIG. 4, and the point cloud 502 may correspond to the point cloud 403 of FIG. 4. The mobile machine may select a target tunnel from the tunnel candidates based on a planned path 501. For example, the mobile machine may select a tunnel (e.g., the third tunnel candidate T₃) that intersects with the planned path 501 among the tunnel candidates as the target tunnel.

The mobile machine may determine spaces between consecutive points to be the tunnel candidates. The mobile machine may measure distances between points of the point cloud 502 and may identify the consecutive points having distances exceeding a threshold among the points. For example, the mobile machine may sense the surrounding objects in a certain rotational direction (e.g., a clockwise direction or a counterclockwise direction) and may sense the consecutive points through the sensing. The consecutive points may have different distances. In an example case in which a distance between two consecutive points exceeds the threshold, a space between the two consecutive points may be determined as a tunnel candidate.

For example, after a first point is sensed, a second point after the first point may be sensed. The first point and the second point may be the consecutive points. In an example case in which the distance between the first point and the second point is less than the threshold, the first point and the second point may be classified into the same group. In an example case in which the distance between the first point and the second point is greater than or equal to the threshold, the first point and the second point may be classified respectively into different groups. In this case, a space between the first point and the second point may be determined as a tunnel candidate.

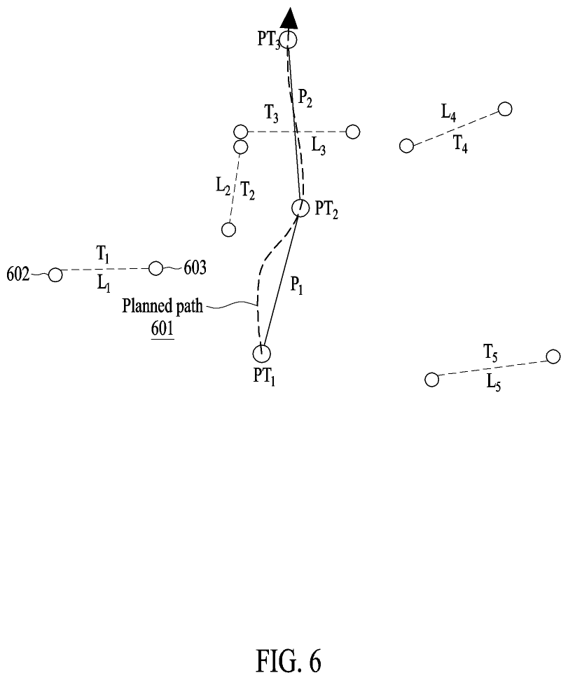

FIG. 6 is a diagram illustrating an example of a process of determining a target tunnel from the tunnel candidates, according to an embodiment. Referring to FIG. 6, a mobile machine may determine tunnel lines based on the tunnel candidates. The tunnel lines may include, but is not limited to, a first tunnel line L₁, a second tunnel line L₂, a third tunnel line L₃, a fourth tunnel line L₄, and a fifth tunnel line L₅. For example, the mobile machine may determine the tunnel lines (e.g., the first to fifth tunnel lines L₁ to L₅) crossing the passing areas of the tunnel candidates (e.g., the first to fifth tunnel candidates T₁ to T₅). A passing area may be an area between points (e.g., a first point 602 and a second point 603) selected from each of the neighboring point groups (e.g., a first point group including the first point 602 on the left side of the first tunnel candidate T₁ and a second point group including the second point 603 on the right side of the first tunnel candidate T₁) of a tunnel (e.g., one of the first to fifth tunnel candidates T₁ to T₅).

The mobile machine may determine path points at regular distances on a planned path 601. However, the disclosure is not limited thereto, and as such, the mobile machine may determine path points at irregular distances on a planned path 601. For example, the path points may include, but is not limited to, a first path point PT₁, a second path point PT₂ and a third path point PT₃. The mobile machine may determine sub-path lines (e.g., a first sub-path line P₁ and a second sub-path line P₂) between the path points. The mobile machine may determine lines connecting neighboring path points (e.g., the first and second path points PT₁ and PT₂ or the second and third path points PT₂ and PT₃) to each other among the path points as the sub-path lines. The mobile machine may select the target tunnel (e.g., the third tunnel candidate T₃) from among the tunnel candidates (e.g., the first to fifth tunnel candidates T₁ to T₅) based on a geometrical relationship between the tunnel lines and the sub-path lines.

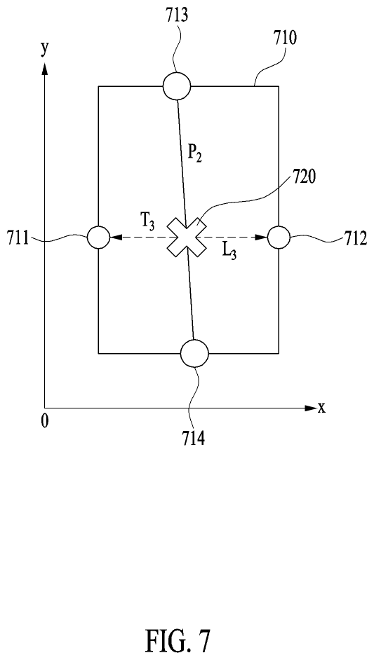

FIG. 7 is a diagram illustrating an example of a process of determining a target tunnel by using a tunnel line and a sub-path line. Referring to FIG. 7, the third tunnel line L₃ of the third tunnel candidate T₃ may form an intersection point 720 with the second sub-path line P₂, and the intersection point 720 may be in an area 710 formed by the third tunnel line L₃ and the second sub-path line P₂. For example, the area 710 may be a rectangle, and points 711 and 712 of both ends of the third tunnel line L₃ and points 713 and 714 of both ends of the second sub-path line P₂ may be on each side of the rectangle.

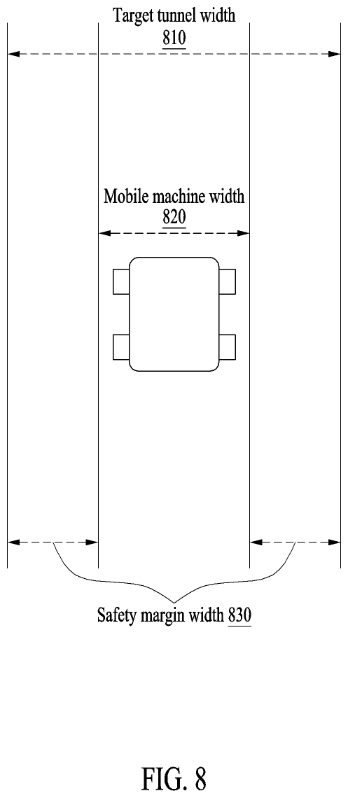

FIG. 8 is a diagram illustrating an example of a process of determining a safety margin width, according to an embodiment. Referring to FIG. 8, a mobile machine may determine a safety margin width 830 based on a target tunnel width 810 and a mobile machine width 820. For example, the mobile machine may set the safety margin width 830 to correspond to the difference between the mobile machine width 820 and the target tunnel width 810. In an example case in which the mobile machine is projected as a rectangle from a bird's eye view, the mobile machine width 830 may be determined to be perpendicular to the frontal direction of the mobile machine.

The mobile machine width 820 may be fixed. The safety margin width 830 may adjust adaptively to fit a surrounding situation (e.g., the target tunnel width 810) of the mobile machine. In an example case in which the target tunnel width 810 increases, the safety margin width 830 may also increase, and, in an example case in which the target tunnel width 810 decreases, the safety margin width 830 may also decrease. The safety margin width 830 may be determined based on a safety area set around the mobile machine and a cost map set around surrounding objects. For example, the safety margin may be shared one-to-one by the safety area and the cost map or may be shared at a greater ratio by any one of the safety area and the cost map. According to another embodiment, the entirety of the safety margin may be distributed across the safety area or the cost map.

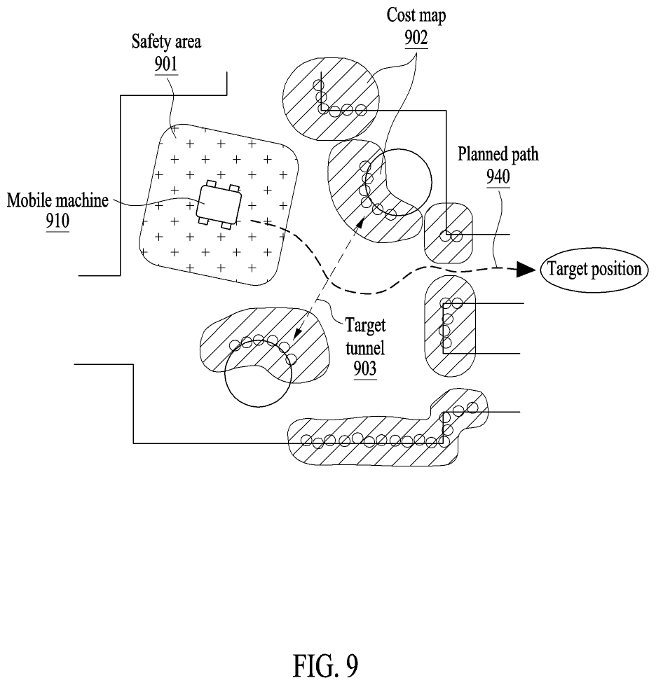

FIG. 9 is a diagram illustrating an example of a situation where a wide safety margin is set, according to an embodiment, and FIG. 10 is a diagram illustrating an example of a situation where a narrow safety margin is set, according to an embodiment. Referring to FIG. 9, a mobile machine 910 may pass through a first target tunnel 903 to move along a planned path 940. The first target tunnel 903 may have a relatively wide width. In this case, the mobile machine 910 may set a relatively wide safety margin. The safety margin may be shared by the safety area 901 and/or a cost map 902. In an example case in which a narrow safety margin is used, the mobile machine 910 may pass through the first target tunnel 903 closely to the surrounding objects of the first target tunnel 903. In this case, unexpected situations may not be readily dealt with and movement safety may decrease. The mobile machine 910 may stably pass through the first target tunnel 903 by using a wide safety margin set based on the wide width of the first target tunnel 903.

Referring to FIG. 10, a mobile machine 1010 may pass through a second target tunnel 1003 to continue to move along a planned path 1040 after passing through the first target tunnel 903 of FIG. 9. The second target tunnel 1003 may have a relatively narrow width. In this case, the mobile machine 1010 may set a relatively narrow safety margin. The safety margin may be shared by a safety area 1002 and/or cost maps 1002 and 1005. In an example case in which a wide safety margin is used, the mobile machine 1010 may not move along the planned path 1040 and may change a path under the determination that the mobile machine 1010 may not pass through the second target tunnel 1003. In this case, movement efficiency may decrease. The mobile machine 1010 may pass through the second target tunnel 1003 by using a narrow safety margin set based on the narrow width of the second target tunnel 1003.

In an example case in which a variable object 1004 suddenly appears, and another narrow tunnel is created, the mobile machine 1010 may pass through the narrow tunnel by narrowing the safety margin. In addition, in an example case in which the moving of the variable object 1004 having formed the narrow tunnel widens the tunnel width, the mobile machine 1010 may stably pass through the tunnel by widening the safety margin.

The mobile machine 1010 may control a moving speed based on the safety margin. For example, as the safety margin is wider, the mobile machine 1010 may increase the moving speed as shown in FIG. 9, and, as the safety margin is narrower, the mobile machine 1010 may decrease the moving speed as shown in FIG. 10. For example, the moving speed may be set proportional to the safety margin.

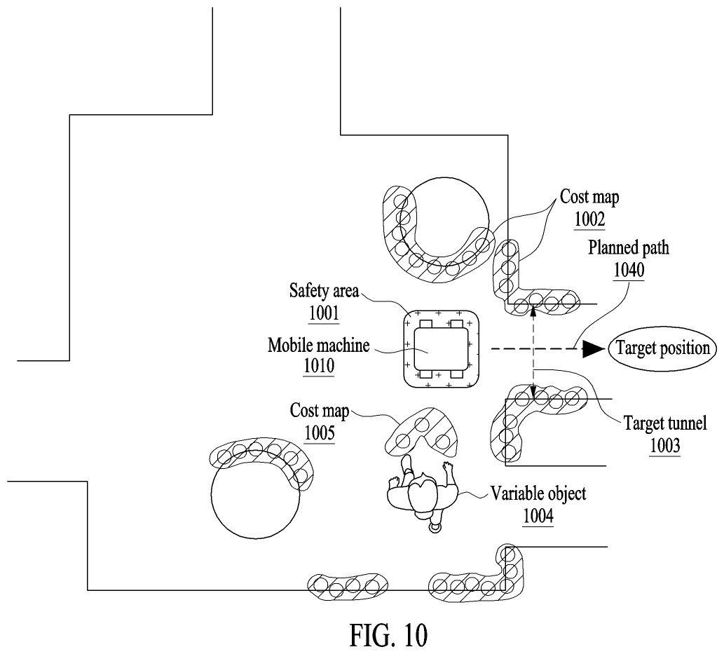

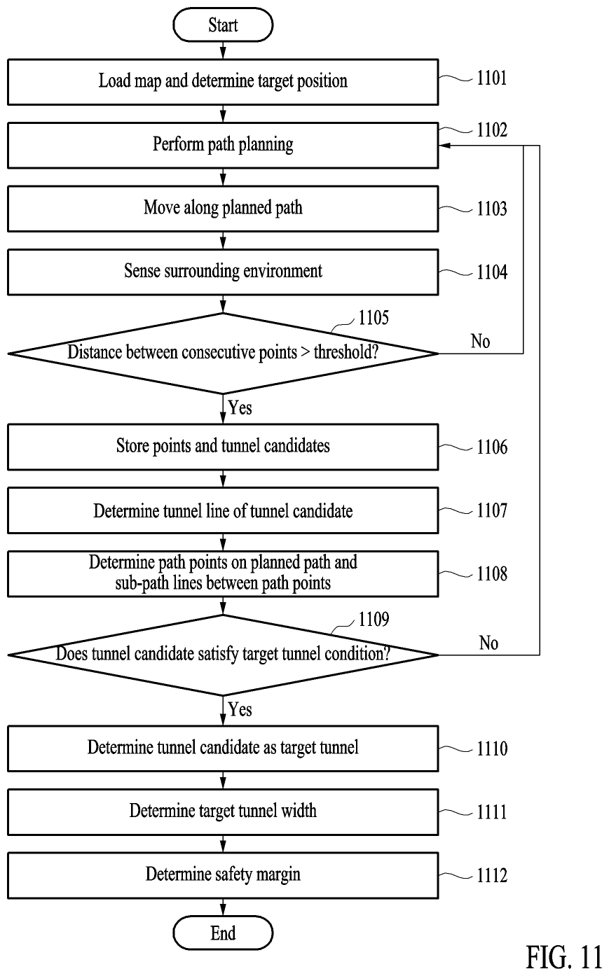

FIG. 11 is a drawing illustrating an example of a detailed operation of a mobile machine for adjusting a safety margin, according to an embodiment. Referring to FIG. 11, in operation 1101, the mobile machine may load a map and may determine a target position. For example, the mobile machine may receive the map from another device distinct from the mobile machine or may generate the map by itself. The target position may be the final position to which the mobile machine is attempting to reach or an intermediate position to reach the final position.

In operation 1102, the mobile machine may perform path planning. The mobile machine may perform position estimation to estimate the current position and may perform the path planning based on the current position and a target position. A planned path may be generated or updated according to the path planning. In operation 1103, the mobile machine may move along the planned path.

In operation 1104, the mobile machine may sense a surrounding environment. As a result of the sensing, a point cloud representing the surrounding objects of the surrounding environment may be generated.

In operation 1105, the mobile machine may check whether a distance between consecutive points of the point cloud is greater than a threshold. Based on the distance is less than the threshold, the mobile machine may perform operation 1102 again. Based on the distance being greater than the threshold, the mobile machine may perform operation 1106. In operation 1106, the mobile machine may store points and tunnel candidates.

The mobile machine may determine a space between points having a distance greater than the threshold as a tunnel candidate and may store the tunnel candidate and the points related to the tunnel candidate.

In operation 1107, the mobile machine may determine a tunnel line of the tunnel candidate. In operation 1108, the mobile machine may determine path points on the planned path and sub-path lines between the path points. For example, a predetermined number of the path points may be determined on the planned path. For example, the path points may be arranged at equal distances on the planned path. Sub-path lines connecting neighboring path points may be determined.

In operation 1109, the mobile machine may check whether the tunnel candidate satisfies a target tunnel condition. The target tunnel condition may include a tunnel line forming an intersection point with a sub-path line among the sub-path lines and/or the intersection point being within an area formed by the tunnel line and the sub-path line. In an example case in which the tunnel candidate does not satisfy the target tunnel conditions, operation 1102 may be performed again. In an example case in which the tunnel candidate satisfies the target tunnel conditions, operation 1110 may be performed.

In operation 1110, the mobile machine may determine the tunnel candidate as a target tunnel. In operation 1111, the mobile machine may determine a target tunnel width. In operation 1112, the mobile machine may determine a safety margin. For example, the mobile machine may determine the safety margin that is narrower than the target tunnel width and wider than a mobile machine width.

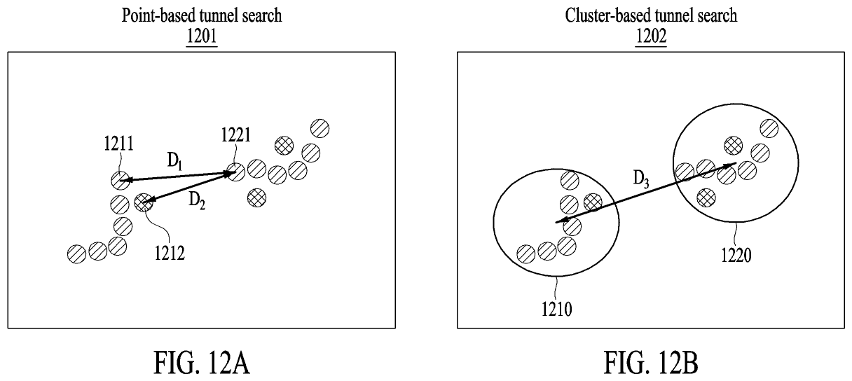

FIGS. 12A and 12B are diagrams illustrating an example of a point-based tunnel search and a cluster-based tunnel search, according to an embodiment. For example, FIG. 12A illustrates an example in which a mobile machine performs a point-based tunnel search 1201 and FIG. 12B illustrates an example in which a mobile machine performs a cluster-based tunnel search 1202. As illustrated in FIG. 12B, a first point group 1210 and a second point group 1220 may be respectively at both ends of a target tunnel. The mobile machine may determine point clustering to determine the first point group 1210 and the second point group 1220.

Referring to FIG. 12A, in an example case in which the point-based tunnel search 1201 is performed, the mobile machine may search for a tunnel candidate based on a distance between points. For example, a first point 1211 and a second point 1221 may be consecutive points. In an example case in which a first distance D₁ between the first point 1211 and the second point 1221 exceeds a threshold, the mobile machine may determine a space between the first point 1211 and the second point 1221 as the tunnel candidate.

In an example case in which there is noise, like a third point 1212, the tunnel candidate may not be found by using the point-based tunnel search 1201. In an example case in which a second distance D₂ between the second point 1221 and the third point 1212 is less than the threshold, the tunnel candidate may not be found between the second point 1221 and the third point 1212. In this case, the mobile machine may not use an optimal path.

Referring to FIG. 12B, in an example case in which the cluster-based tunnel search 1202 is performed, the mobile machine may determine the tunnel candidate by using a third distance D₃ between a first center of the first point group 1210 and a second center of the search point group 1220. In an example case in which the third distance D₃ exceeds the threshold, the mobile machine may determine a space between the first point group 1210 and the second point group 1220 as the tunnel candidate. In an example case in which the cluster-based tunnel search 1202 is performed, the tunnel candidate may be searched for robustly against the noise, like the third point 1212.

According to an embodiment, the mobile machine may selectively perform the point-based tunnel search 1201 and the cluster-based tunnel search 1202. For example, the mobile machine may determine tunnel candidates based on the distance between the first point 1211 and the second point 1221 that are the closest to each other among the first points of the first point group 1210 and the second points of the second point group 1220, a distance between the first center of the first point group 1210 and the second center of the second point group 1220, or a combination thereof. For example, the mobile machine may analyze a noise level of a point cloud and may perform the point-based tunnel search 1201 and the cluster-based tunnel search 1202 selectively based on the noise level. In an example case in which the noise level is lower than a threshold, the point-based tunnel search 1201 may be performed, and, in an example case in which the noise level is higher than the threshold, the cluster-based tunnel search 1202 may be performed.

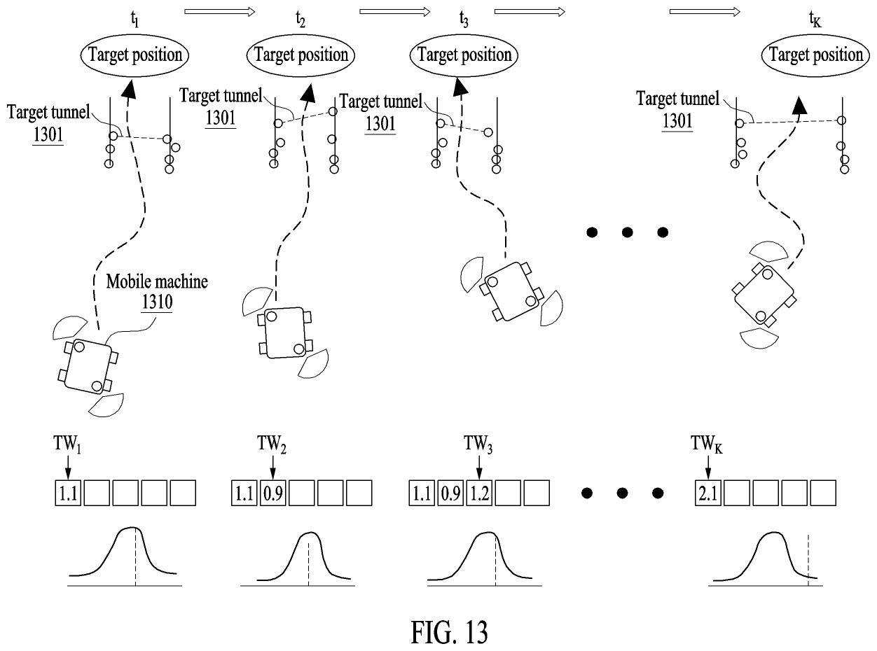

FIG. 13 is a diagram illustrating an example of a process of updating the width of a target tunnel, according to an embodiment. Referring to FIG. 13, a mobile machine 1310 may determine the target tunnel width of a target tunnel 1301 based on the distribution of points obtained by sensing the target tunnel 1301. Although an actual target tunnel width is fixed, the distribution of the points may change continuously depending on a pose change of the mobile machine 1310, and, accordingly, a value of the target tunnel width may continue to be sensed differently. For example, the target tunnel width may be sensed by a first value TW₁ at a first time t₁, a second value TW₂ at a second time t₂, a third value TW₃ at a third time t₃, and a Kth value TW_{K} at a Kth time t_{K}.

The mobile machine 1310 may update the target tunnel width continuously according to the change of the sensed value of the target tunnel width or may update the target tunnel width under update conditions. In an example case in which the target tunnel width is updated every time the value of the target tunnel width changes, inefficient operations may be performed. Operation efficiency may be improved by updating the target tunnel width under the update conditions.

According to an embodiment, the update conditions may be set based on the distribution of the values (e.g., the first to Kth values TW₁ to TW_{K}) of the target tunnel width. The target tunnel width may be updated in an example case in which a new value outside the distribution of the previously sensed values is sensed. A mobile machine may determine the target tunnel width to be a first value in an example case in which the target tunnel width is sensed as the first value in a first pose of the mobile machine. The mobile machine may determine the target tunnel width to be the first value or a second value based on the difference between the first value and the second value in an example case in which the target tunnel width is sensed as the second value in a second pose of the mobile machine according to a pose change (e.g., moving) of the mobile machine.

For example, the update conditions may include the difference with a reference value exceeding a threshold. For example, the reference value may be an initial value of the target tunnel width upon the finding of the target tunnel width. For example, the first value TW₁ may be the initial value, and the target tunnel width may not be updated in an example case in which the differences between the first value TW₁ and the sensed second and third values TW₂ and TW₃ are less than the threshold. The difference between the first value TW₁ and the Kth value TW_{K} sensed after the third value TW₃ exceeds the threshold, the target tunnel width may be updated to the Kth value TW_{K}.

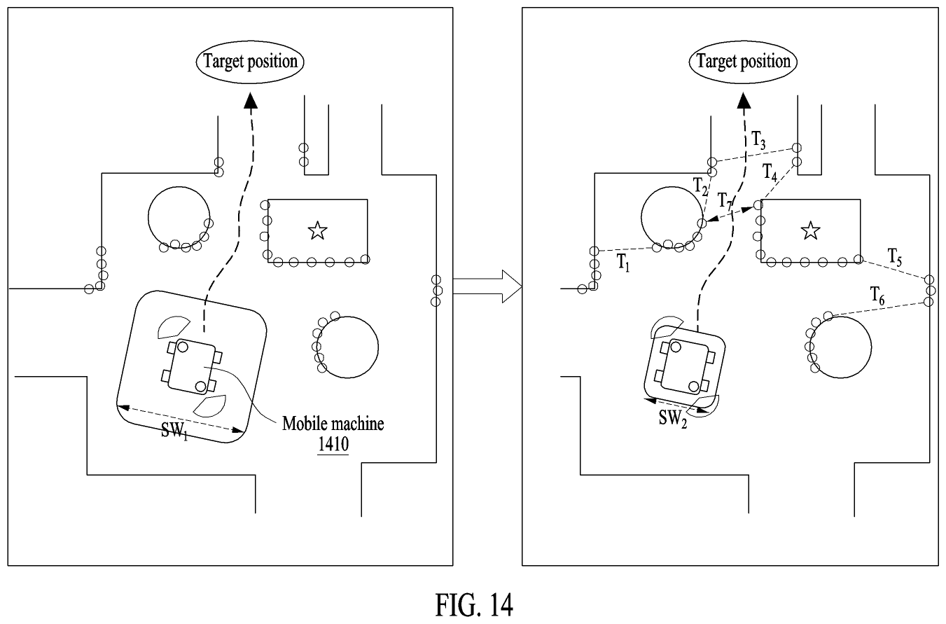

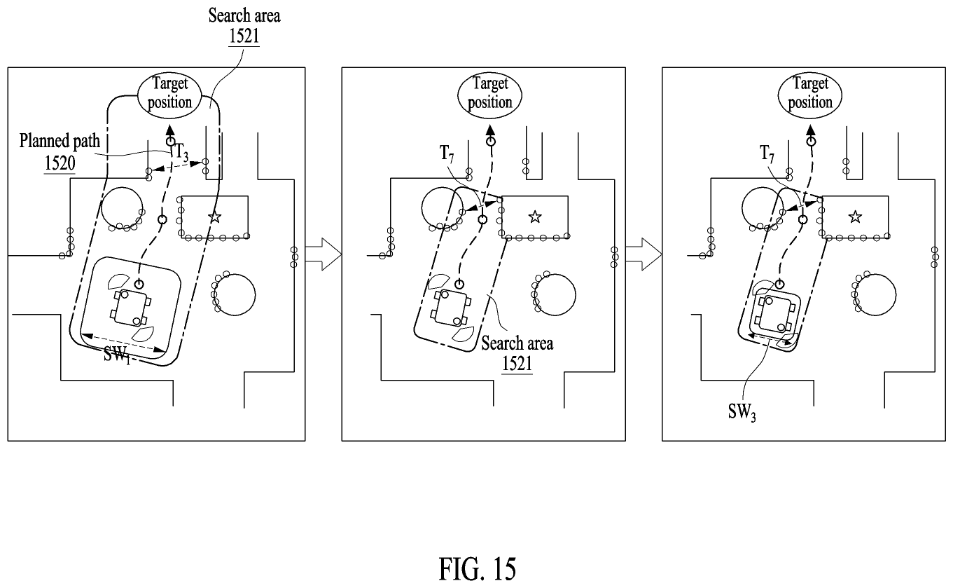

FIG. 14 is a diagram illustrating an example of a tunnel search process using all points of a point cloud without a search area, according to an embodiment, and FIG. 15 is a diagram illustrating an example of a tunnel search process using partial points of a point cloud by using a search area, according to an embodiment.

Referring to FIG. 14, a mobile machine 1410 may sense a surrounding environment in a certain rotational direction (e.g., a clockwise direction or a counterclockwise direction) and may sense consecutive points through the sensing. The consecutive points may have certain distances. In an example case in which a distance between two consecutive points exceeds the threshold, a space between the two consecutive points may be determined as a tunnel candidate.

First to sixth tunnel candidates T₁ to T₆ may be determined through this sensing in a certain rotational direction. In an example case in which points are not sensed consecutively, a tunnel may not be obtained. The mobile machine 1410 may determine the third tunnel candidate T₃ as a target tunnel. The mobile machine 1410 may update a first safety margin width SW₁ to a second safety margin width SW₂ and may move along a planned path. The tunnel width of the seventh tunnel T₇ may be narrower than the second safety margin width SW₂. The omission of the seventh tunnel T₇ may cause the mobile machine 1410 to not pass through the seventh tunnel T₇ or crash into the seventh tunnel T₇.

Referring to FIG. 15, a mobile machine 1510 may perform a tunnel search by using a search area 1521. The mobile machine 1510 may set a certain area around a planned path 1520 as the search area 1521. For example, the mobile machine 1510 may set the search area 1521 based on the third tunnel candidate T₃ on the planned path 1520. For example, the mobile machine 1510 may set the search area 1521 to include the third tunnel candidate T₃ based on the tunnel width of the third tunnel candidate T₃.

The mobile machine 1510 may determine tunnel candidates from points in the search area 1521 in the point cloud. The points in the search area 1521 may be some points of all points of the point cloud. The mobile machine 1510 may determine the seventh tunnel candidate T₇ as the target tunnel from those points. The mobile machine 1510 may determine the seventh tunnel candidate T₇ as the target tunnel on the planned path, may update the first safety margin width SW₁ to the third safety margin width SW₃ based on the tunnel width of the seventh tunnel T₇, and may move along the planned path. The detection of the seventh tunnel T₇ may cause the mobile machine 1410 to pass through the seventh tunnel T₇ by using the third safety margin width SW₃.

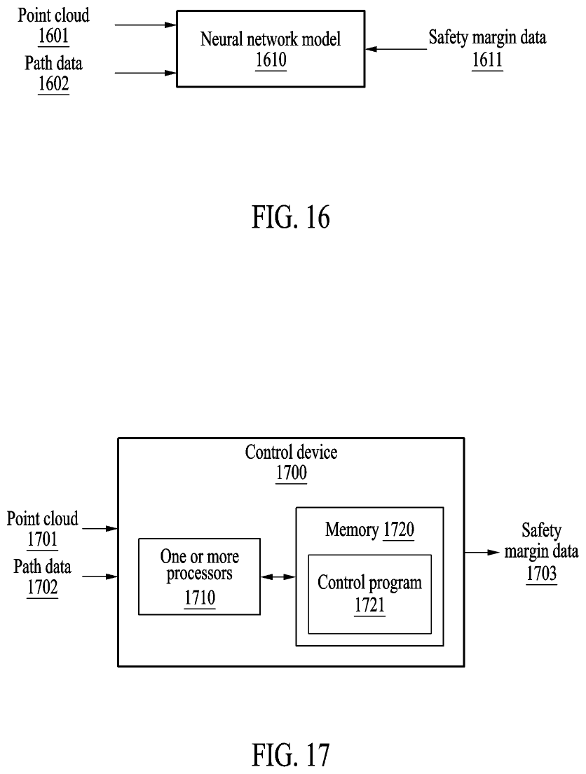

FIG. 16 is a diagram illustrating an example of a process of estimating safety margin data by using a neural network model, according to an embodiment. Referring to FIG. 16, a mobile machine may input a point cloud 1601 and/or path data 1602 into a neural network model 1610, may execute the neural network model 1610, and may obtain safety margin data 1611. The path data 1602 may include a planned path. The safety margin data 1611 may include a safety margin.

The neural network model 1610 may be pre-trained to output the safety margin data 1611 according to the input of the point cloud 1601 and/or the path data 1602 by using large-scale training data. For example, the neural network model 1610 may include a point net, a convolutional neural network (CNN), a recurrent neural network (RNN), a large language model (LLM), or a combination thereof. In an example case in which the neural network model 1610 includes the CNN, the point cloud 1601 and the path data 1602 may be converted into image data and may be input to the CNN. In an example case in which the neural network model 1610 includes the LLM, the point cloud 1601 and the path data 1602 may be converted into token data and may be input to the neural network model 1610. The neural network model 1610 may estimate the safety margin with high accuracy in environments where there is much noise or obstacles are set complexly.

FIG. 17 is a block diagram illustrating an example of a configuration of a control device for a mobile machine, according to an embodiment. Referring to FIG. 17, a control device 1700 may receive a point cloud 1701 and path data 1702 and may generate safety margin data 1703 based on the point cloud 1701 and the path data 1702. The control device 1700 may include one or more processors 1710 and a memory 1720. The memory 1720 may store a control program 1721. The control device 1700 may generate the safety margin data 1703 by using the control program 1721. According to an embodiment, the mobile machine may include the control device 1700 specialized in safety margin control. The control device 1700 may be provided as a plug-in to the mobile machine for performing path planning 210 and position estimation 260 of FIG. 2. The control device 1700 may be provided as a plug-in to the mobile machine for performing safety margin control 270 of FIG. 2.

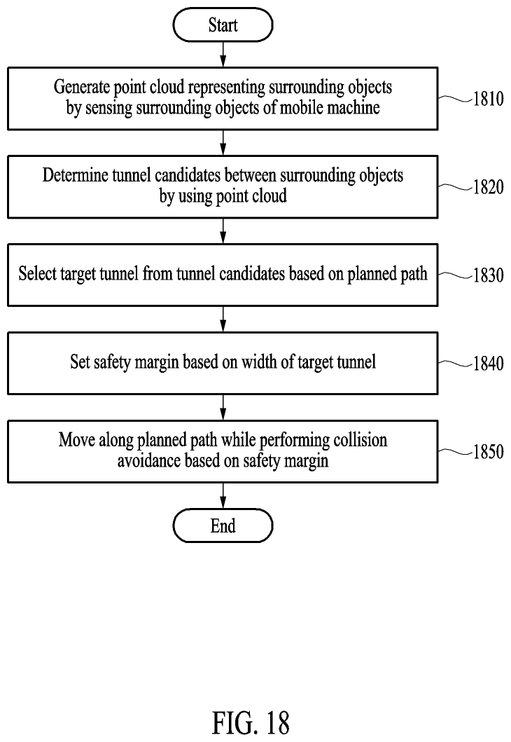

FIG. 18 is a flowchart illustrating a controlling method of a mobile machine, according to an embodiment. Referring to FIG. 18, the mobile machine may generate a point cloud representing surrounding objects by sensing the surrounding objects of the mobile machine in operation 1810, may determine tunnel candidates between the surrounding objects by using the point cloud in operation 1820, may select a target tunnel from the tunnel candidates based on a planned path in operation 1830, may set a safety margin based on the width of the target tunnel in operation 1840, and may move along the planned path while performing collision avoidance based on the safety margin in operation 1850.

In operation 1820, the method may include the measuring of distances between points of the point cloud, the identifying of consecutive points having a distance exceeding a threshold among the points, and the determining of a space between the consecutive points to be the tunnel candidates.

In operation 1830, the method may include the selecting of a tunnel intersecting with the planned path as the target tunnel from among the tunnel candidates.

In operation 1830, the method may include the determining of tunnel lines crossing a passing area of the tunnel candidates, the determining of sub-path lines between path points on the planned path, and the selecting of the target tunnel based on a geometric relationship between the tunnel lines and the sub-path lines.

The tunnel candidates may include a first tunnel candidate having a first tunnel line among the tunnel lines, and the selecting of the target tunnel based on a geometric relationship may include, when the first tunnel line forms an intersection point with a first sub-path line among the sub-path lines, and the intersection point is within an area formed by the first tunnel line and the first sub-path line, the selecting of the first tunnel candidate as the target tunnel.

In operation 1840, the method may include the setting of the width of the safety margin to correspond to the difference between the width of the mobile machine and the width of the target tunnel.

The mobile machine may control a moving speed based on the safety margin.

The controlling of the moving speed may include the increasing of the moving speed as the safety margin is wider, and the decreasing of the moving speed as the safety margin is narrower.

The safety margin may be determined based on a safety area set around the mobile machine and a cost map set around the surrounding objects.

According to an embodiment, a first point group and a second point group are at both ends of the target tunnel, and in operation 1820, the method may include determining of the tunnel candidates based on a distance between a first point and a second point that are the closest to each other among first points of the first point group and second points of the second point group, the distance between a first center of the first point group and a second center of the second point group, or a combination thereof.

The mobile machine may determine the width of the target tunnel.

The determining of the width of the target tunnel may include the determining of the target tunnel width to be a first value based on the width of the target tunnel being sensed as a first value in a first pose of the mobile machine and the determining of the width of the target tunnel to be the first value or a second value based on a difference between the first value and the second value based on the width of the target tunnel being sensed as the second value in a second pose of the mobile machine according to a pose change of the mobile machine.

In operation 1820, the method may include the setting of a certain area around the planned path as a search area and the determining of the tunnel candidates from points in the search area in the point cloud.

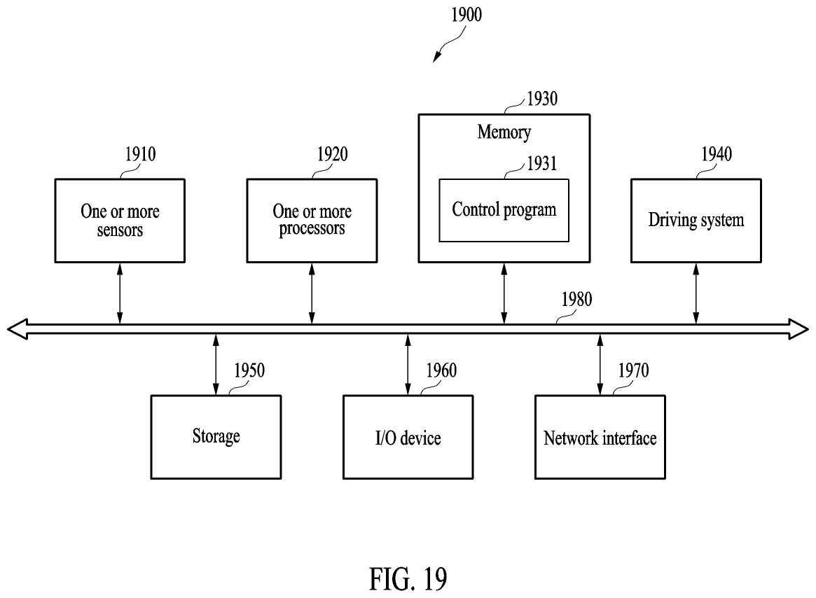

FIG. 19 is a block diagram illustrating an example of a configuration of a mobile machine, according to an embodiment. Referring to FIG. 19, a mobile machine 1900 may include one or more sensors 1910, one or more processors 1920, a memory 1930, a driving system 1940, a storage 1950, an input/output (I/O) device 1960, and a network interface 1970. These components may communicate with one another via a communication bus 1980. However, the disclosure is not limited thereto, and as such, according to another embodiment, the The one or more sensors 1910 may include LiDAR, an image sensor, a depth sensor, an ultrasonic sensor, or a combination thereof. The one or more processors 1920 may execute instructions stored in the memory 1930 or the storage 1950. When executed by the one or more processors 1920, the instructions may cause the mobile machine 1900 to perform the operations described with reference to FIGS. 1 to 18. The memory 1930 may include a non-transitory computer-readable storage medium or a non-transitory computer-readable storage device. For example, the one or more processors 1920 may be an integrated control device for performing autonomous driving including a safety margin control.

The memory 1930 may store instructions to be executed by the one or more processors 1920 and may store related information while software and/or an application is being executed by the mobile machine 1900. The memory 1930 may store a control program 1931. When at least a portion of the control program 1931 is stored in the memory 1930, the operations described with reference to FIGS. 1 to 18 may be performed by the mobile machine 1900. The driving system 1940 may include components, such as power generation components (e.g., motors), power transmission components, steering components, or drivers, for implementing driving.

The storage 1950 may include a computer-readable storage medium or a computer-readable storage device. The storage 1950 may store more information than the memory 1930 for a long time. For example, the storage 1950 may include a magnetic hard disk, an optical disc, a flash memory, a floppy disk, or other non-volatile memories known in the art.

The I/O device 1960 may receive an input from the user in traditional input manners through a keyboard and a mouse, and in new input manners, such as a touch input, a voice input, and an image input. For example, the I/O device 1960 may include a keyboard, a mouse, a touch screen, a microphone, or any other device that detects the input from the user and transmits the detected input to the mobile machine 1900. The I/O device 1960 may provide an output of the mobile machine 1900 to the user through a visual, auditory, or haptic channel. The I/O device 1960 may include, for example, a display, a touch screen, a speaker, a vibration generator, or any other device that provides the output to the user. The network interface 1970 may communicate with an external device through a wired or wireless network.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, according to some embodiments, suitable results may be achieved by performing the described techniques in a different order and/or by omitting combining, replacing and/or supplementing components in a system, architecture, device, or circuit described above in a different manner. For example, in some embodiments, components in a system, architecture, device, or circuit described above may be combined, replaced and/or supplemented with other components or their equivalents).

Accordingly, other implementations are within the scope of the following claims.

What is claimed is:

1. A method of moving a mobile machine, the method comprising:
generating a point cloud corresponding to a plurality of objects in an area surrounding the mobile machine;
determining tunnel candidates based on the point cloud corresponding to the plurality of objects;
selecting a target tunnel from the tunnel candidates based on a planned path;
setting a safety margin based on a width of the target tunnel; and
moving along the planned path based on the safety margin.

2. The method of claim 1, wherein the determining the tunnel candidates comprises:
measuring distances between a plurality of points of the point cloud corresponding to the plurality of objects;
identifying consecutive points having a distance exceeding a threshold among the plurality of points; and
determining a space between the consecutive points to be the tunnel candidates.

3. The method of claim 1, wherein the selecting the target tunnel comprises selecting a tunnel intersecting with the planned path as the target tunnel from among the tunnel candidates.

4. The method of claim 1, wherein the selecting the target tunnel comprises:
determining tunnel lines crossing a passing area of the tunnel candidates;
determining sub-path lines between path points on the planned path; and
selecting the target tunnel based on a spatial relationship between the tunnel lines and the sub-path lines.

5. The method of claim 4, wherein the tunnel candidates comprise a first tunnel candidate having a first tunnel line among the tunnel lines, and
wherein the selecting the target tunnel based on the spatial relationship comprises, based on the first tunnel line forming an intersection point with a first sub-path line among the sub-path lines, and the intersection point is within an area formed by the first tunnel line and the first sub-path line, selecting the first tunnel candidate as the target tunnel.

6. The moving method of claim 1, wherein the setting the safety margin comprises setting a width of the safety margin based on a difference between a width of the mobile machine and the width of the target tunnel.

7. The method of claim 1, further comprises controlling a moving speed based on the safety margin.

8. The method of claim 7, wherein the controlling the moving speed comprises increasing the moving speed as the safety margin is wider and decreasing the moving speed as the safety margin is narrower.

9. The method of claim 1, wherein the safety margin is determined based on a safety area set around the mobile machine and a cost map set around the plurality of objects.

10. The method of claim 1, wherein a first point group is at a first end of the target tunnel and a second point group is at a second end of the target tunnel, and wherein the determining the tunnel candidates comprises determining the tunnel candidates based on a first distance between a first point, among first points of the first point group, and a second point, among second points of the second point group, that are the closest to each other, a second distance between a first center of the first point group and a second center of the second point group, or a combination of the first distance and the second distance.

11. The method of claim 1, further comprises determining the width of the target tunnel.

12. The method of claim 11, wherein the determining the width of the target tunnel comprises:
determining the width of the target tunnel to be a first value based on the width of the target tunnel being sensed as the first value in a first pose of the mobile machine; and
determining the width of the target tunnel to be the first value or a second value based on a difference between the first value and the second value based on the width of the target tunnel being sensed as the second value in a second pose of the mobile machine according to a pose change of the mobile machine.

13. The method of claim 1, wherein the determining the tunnel candidates comprises:
setting a first area around the planned path as a search area; and
determining the tunnel candidates from points in the search area in the point cloud.

14. A controlling method of a mobile machine, the controlling method comprising:
receiving a point cloud corresponding to a plurality of objects in an area surrounding the mobile machine;
determining tunnel candidates based on the point cloud corresponding to the plurality of objects;
selecting a target tunnel from the tunnel candidates based on a planned path; and
determining a safety margin for collision avoidance based on a difference between a width of the mobile machine and a width of the target tunnel.

15. The controlling method of claim 14, wherein the determining the tunnel candidates comprises:
measuring distances between a plurality of points of the point cloud corresponding to the plurality of objects;
identifying consecutive points having a distance exceeding a threshold among the plurality of points; and
determining a space between the consecutive points to be the tunnel candidates.

16. The controlling method of claim 14, wherein the selecting the target tunnel comprises selecting a tunnel intersecting with the planned path as the target tunnel from among the tunnel candidates.

17. The controlling method of claim 14, wherein the selecting the target tunnel comprises:
determining tunnel lines crossing a passing area of the tunnel candidates;
determining sub-path lines between path points on the planned path; and
selecting the target tunnel based on a spatial relationship between the tunnel lines and the sub-path lines.

18. The controlling method of claim 14, wherein the setting the safety margin comprises setting a width of the safety margin based on a difference between a width of the mobile machine and the width of the target tunnel.

19. The controlling method of claim 14, wherein the safety margin is set based on a safety area set around the mobile machine and a cost map set around the plurality of objects.

20. A mobile machine comprising:
one or more sensors configured to sense a plurality of objects in an area surrounding the mobile machine;
one or more processors configured to:
determine tunnel candidates based on a point cloud corresponding to the plurality of objects,
select a target tunnel from the tunnel candidates based on a planned path, and
set a safety margin based on a width of the target tunnel; and
a driving system configured to move the mobile machine along the planned path based on the safety margin.
